(19) United States
(12) Patent Application Publication
(10) Pub. No.: US 2021/0285781 A1
(43) Pub. Date: Sep. 16, 2021

(54) VEHICLE FOLLOWING TRAVEL SYSTEM, INFORMATION PROCESSING METHOD, AND STORAGE MEDIUM

(71) Applicant: HONDA MOTOR CO., LTD., Tokyo (JP)

(72) Inventors: Satoshi KOIKE, Wako-shi (JP); Ryuichi HATA, Wako-shi (JP); Naoyuki KUBO, Wako-shi (JP); Takayuki SAKATA, Wako-shi (JP); Masayasu YOSHIDA, Wako-shi (JP); Mitsuru NONAKA, Tokyo (JP); Seiichi KATO, Tokyo (JP); Masanori YOSHIHIRA, Wako-shi (JP)

(21) Appl. No.: 17/185,121

(22) Filed: Feb. 25, 2021

(30) Foreign Application Priority Data
Mar. 12, 2020 (JP) 2020-043262

(51) Int. Cl. G01C 21/34; G06Q 30/02; B60W 30/165

(52) U.S. Cl. CPC G01C 21/3476; B60W 30/165; G06Q 30/0207; G01C 21/3438

(57) ABSTRACT

There is provided with a vehicle following travel system configured to cause a following vehicle to perform following travel following a leading vehicle. A departure point and a destination desired by a user of the following vehicle and a rest condition desired by the user of the following vehicle is obtained. Based on the departure point and the destination, for the leading vehicle that the following vehicle follows is searched. A travel plan that includes a section of the following travel in at least a part between the departure point and the destination and further includes a rest complying with the rest condition is generated.

### CROSS-REFERENCE TO RELATED APPLICATION(S)

This application claims priority to and the benefit of Japanese Patent Application No. 2020-043262 filed on Mar. 12, 2020, the entire disclosure of which is incorporated herein by reference.

### BACKGROUND OF THE INVENTION

### Field of the Invention

The present invention relates to a vehicle following travel system, an information processing method, and a storage medium.

### Description of the Related Art

To implement automated driving, a following travel system in which a following vehicle travels following a leading vehicle has been proposed. Japanese Patent Laid-Open No. 2019-001227 discloses a technique of controlling a following vehicle such that the distance to a preceding vehicle is maintained in accordance with a target track following the travel track of the preceding vehicle. Also, Japanese Patent Laid-Open No. 2019-156197 discloses a technique of limiting braking, driving, or steering of a preceding vehicle based on the vehicle performance of a following vehicle. Furthermore, International Publication No. 2016/113890 discloses a technique of selecting a leading vehicle based on the scheduled travel course of a following vehicle and presenting, to the user of the following vehicle, information representing a travel plan and the leading vehicle to be followed.

### SUMMARY OF THE INVENTION

According to one embodiment of the present disclosure, a vehicle following travel system configured to cause a following vehicle to perform following travel following a leading vehicle, comprises: a memory storing a program, and; one or more processor which, by executing the program, perform: obtaining a departure point and a destination desired by a user of the following vehicle and a rest condition desired by the user of the following vehicle; searching, based on the departure point and the destination, for the leading vehicle that the following vehicle follows; and generating a travel plan that includes a section of the following travel in at least a part between the departure point and the destination and further includes a rest complying with the rest condition.

According to another embodiment of the present disclosure, an information processing method performed by a vehicle following travel system configured to cause a following vehicle to perform following travel following a leading vehicle, comprises; obtaining a departure point and a destination desired by a user of the following vehicle and a rest condition desired by the user of the following vehicle; searching, based on the departure point and the destination, for the leading vehicle that the following vehicle follows; and generating a travel plan that includes a section of the following travel in at least a part between the departure point and the destination and further includes a rest complying with the rest condition.

According to still another embodiment of the present disclosure, a non-transitory computer-readable storage medium storing a program that, when executed by a computer, causes the computer to perform an information processing method performed by a vehicle following travel system configured to cause a following vehicle to perform following travel following a leading vehicle, comprises: obtaining a departure point and a destination desired by a user of the following vehicle and a rest condition desired by the user of the following vehicle; searching, based on the departure point and the destination, for the leading vehicle that the following vehicle follows, and generating a travel plan that includes a section of the following travel in at least a part between the departure point and the destination and further includes a rest complying with the rest condition.

### BRIEF DESCRIPTION OF THE DRAWINGS

FIG. 1 is a view for explaining an example of following travel according to an embodiment;

FIG. 2 is a block diagram showing an example of the arrangement of a vehicle following travel system according to the embodiment:

FIG. 3 is a block diagram showing an example of the functional arrangement of an information processing apparatus according to the embodiment;

FIG. 4 is a view for explaining information exchange between vehicles and the information processing apparatus according to the embodiment:

FIG. 5 is a view for explaining an example of following travel according to the embodiment:

FIG. 6 is a view for explaining an example of following travel according to the embodiment;

FIG. 7 is a view for explaining an example of following travel according to an embodiment;

FIG. 8 is a flowchart of an information processing method according to the embodiment;

FIG. 9 is a flowchart of an information processing method according to an embodiment; and

FIG. 10 is a block diagram showing an example of the hardware arrangement of the information processing apparatus according to an embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

The user of a following vehicle sometimes wants a rest. In the technique described in patent literature 3, however, since the leading vehicle travels along the scheduled travel course in accordance with a scheduled passing time, it is not easy to stop at a rest place in accordance with the desire of the user of the following vehicle that is following the leading vehicle or going to follow later.

An embodiment of the present invention makes it possible to take a rest in accordance with the desire of the user of a following vehicle in a vehicle following travel system.

### First Embodiment

An embodiment of the present invention is related to a vehicle following travel system in which a following vehicle performs following travel following a leading vehicle. A following travel control method is not particular limited, and, for example, the methods described in patent literatures 1 and 2 can be employed. Following travel according to the embodiment will be described below.

(Following Travel Control)

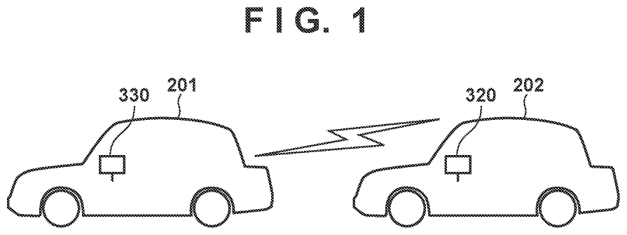

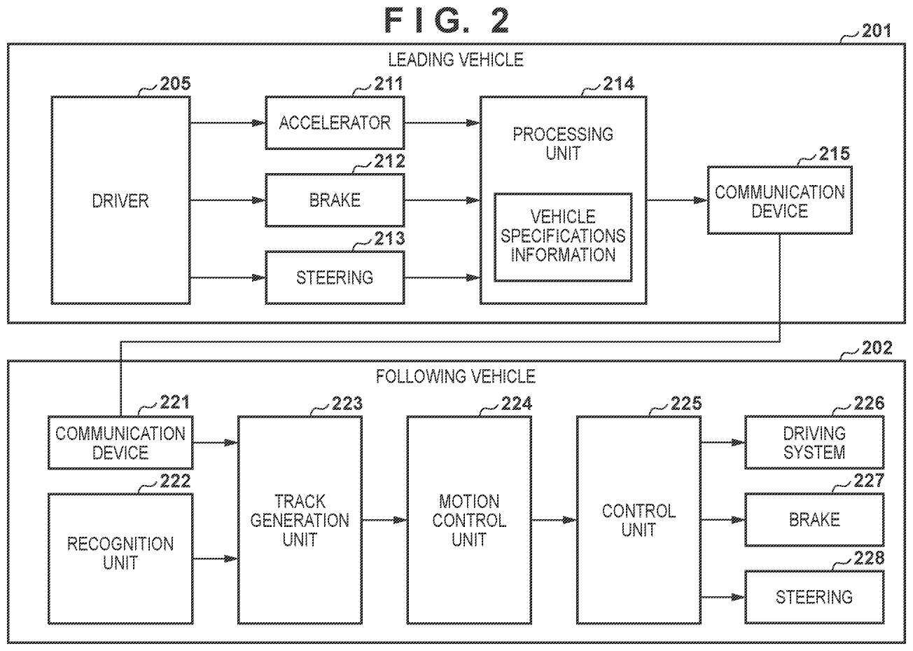

FIG. 1 shows an example of following travel. As shown in FIG. 1, at the time of following travel, a following vehicle 202 can recognize a leading vehicle 201 and perform following travel of following the recognized leading vehicle 201 automatically (without manual driving of the user). The following vehicle 202 may recognize the leading vehicle 201 by vehicle-to-vehicle communication with the leading vehicle 201, or may recognize the leading vehicle 201 using a shape recognition device such as an in-vehicle camera or a laser radar. The following vehicle 202 and the leading vehicle 201 may include, for example, a vehicle motion control system as shown in FIG. 2.

FIG. 2 is a block diagram showing an example of the functional arrangement of the following vehicle 202 and the leading vehicle 201, which perform following travel using vehicle-to-vehicle communication. Referring to FIG. 2, the leading vehicle 201 includes a processing unit 214 and a communication device 215, and the following vehicle 202 includes a communication device 221, a recognition unit 222, a track generation unit 223, a motion control unit 224, and a control unit 225.

The processing unit 214 of the leading vehicle 201 processes pieces of operation information that are the operation amounts of the accelerator 211, the brake 212, and the steering 213 operated by the driver and leading vehicle information formed by the travel state amounts such as a vehicle speed and an acceleration or vehicle specifications. The communication device 215 transmits the leading vehicle information to the following vehicle 202.

The communication device 221 of the following vehicle 202 receives the leading vehicle information transmitted from the leading vehicle 201. The recognition unit 222 obtains leading vehicle recognition information such as the relative distance, the relative speed, or the relative angle between the following vehicle and the leading vehicle. The recognition unit 222 may obtain the leading vehicle recognition information based on the leading vehicle information obtained by the communication device 221 via vehicle-to-vehicle communication, or may obtain the preceding vehicle recognition information using a shape recognition device such as an in-vehicle camera, a LiDAR(LADAR), or a radar.

The track generation unit 223 generates a target track following the travel track of the leading vehicle based on the information obtained by the recognition unit 222. The motion control unit 224 calculates a vehicle motion control instruction for the following vehicle so as to travel following the target track generated by the track generation unit 223. According to the control instruction calculated by the motion control unit 224, the control unit 225 calculates the control amounts of a driving system 226 such as an engine or a drive motor, a brake 227, and a steering 228 associated with steering, braking, and driving, and outputs these.

In addition, the leading vehicle 201 and the following vehicle 202 may each include a notification unit (not shown) that causes a lamp or the like to emit light during following travel to notify the periphery of that. By notifying the periphery of the following travel, cut-in between the leading vehicle 201 and the following vehicle 202 can be prevented. Also, considering a case in which the vehicle needs to be backed up due to a blind lane during following travel, the following vehicle 202 may have a back function by a track storage function, a back function by remote control, or a function of backing by detecting a gesture or the like.

(Travel Plan Generation)

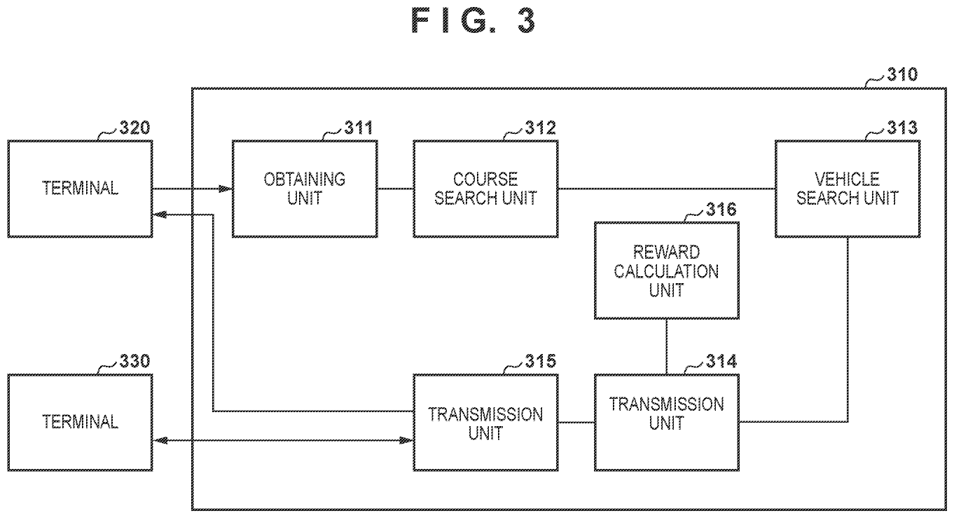

In the vehicle following travel system, a travel plan of the following vehicle 202 can be made such that the following vehicle 202 can follow the leading vehicle 201. FIG. 3 is a block diagram showing an example of the arrangement of the vehicle following travel system. This system includes an information processing apparatus 310, a terminal 320, and a terminal 330. Note that it is not essential that the vehicle following travel system includes all of the information processing apparatus 310, the terminal 320, and the terminal 330. Also, it is not essential that the information processing apparatus 310, the terminal 320, and the terminal 330 are single devices. For example, the vehicle following travel system may be formed by a plurality of information processing apparatuses that are connected via a network and implement the function of the information processing apparatus 310. In addition, some or all of processes to be described below as those performed by the information processing apparatus 310 may be performed by the terminal 320 or the terminal 330.

As shown in FIG. 1, the terminal 320 and the terminal 330 are information processing apparatuses associated with the following vehicle 202 and the leading vehicle 201, respectively. For example, the terminal 320 and the terminal 330 may be in-vehicle terminals such as car navigation terminals provided in the following vehicle 202 and the leading vehicle 201, or may be portable terminals such as smartphones held by the users of the following vehicle 202 and the leading vehicle 201. The terminal 320 is linked with the following vehicle 202. The terminal 320 obtains an operation or information input to the information processing apparatus 310 by the user of the following vehicle 202, and transmits it to the information processing apparatus 310. Details of contents the user inputs here will be described later. Also, the terminal 320 can receive information from the information processing apparatus 310. For example, the terminal 320 may receive a travel plan from the information processing apparatus 310. Similarly, the terminal 330 is linked with the leading vehicle 201, and can transmit information to the information processing apparatus 310 and receive information from the information processing apparatus 310. For example, the terminal 330 can receive a travel plan from the information processing apparatus 310. Here, the terminal 330 may receive the travel plan from the information processing apparatus 310 directly or via a server that manages the travel of the leading vehicle 201.

The information processing apparatus 310 generates a travel plan based on a departure point and a destination desired by the user of the following vehicle 202. The travel plan includes a section of following travel located in at least a part between the departure point and the destination. Here, the information processing apparatus 310 can search for the leading vehicle 201 that the following vehicle 202 follows in the section of following travel. A description will be made below assuming that the information processing apparatus 310 is a server of an application that provides following travel as a service by performing matching with the leading vehicle 201 based on information input by the user of the following vehicle 202 and generating a travel plan, for descriptive convenience.

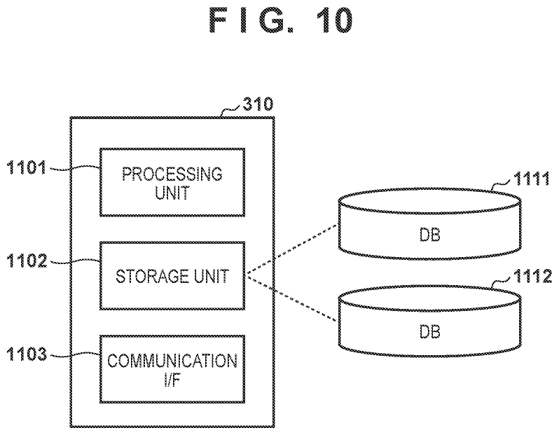

FIG. 10 is a block diagram showing an example of the hardware arrangement of the information processing apparatus 310. The information processing apparatus 310 includes a processing unit 1101, a storage unit 1102, and a communication I/F (interface) 1103. The processing unit 1101 is a processor like a CPU, and executes a program stored in the storage unit 1102. The storage unit 1102 is a storage device such as a RAM, a ROM, or a hard disk, and can store programs and various kinds of data. The communication I/F 1103 is a wired or wireless communication interface. The communication I/F 1103 can communicate with the terminal 320 and the terminal 330 via a communication network. In addition, the communication/F 1103 can communicate with the leading vehicle 201 or the following vehicle 202 via the communication network and the communication device 215 or the communication device 221.

Each function of the information processing apparatus 310 shown in FIG. 3 can be implemented by the processing unit 1101 operating in accordance with a program stored in the storage unit 1102. Note that the functions of the processing unit 214, the recognition unit 222, the motion control unit 224, and the control unit 225 may also be implemented by a processor provided in the leading vehicle 201 or the following vehicle 202, which operates in accordance with a program stored in a memory. Similarly, the operation of the terminal 320 or the terminal 330 to be described later can be implemented by a processor provided in the terminal 320 or the terminal 330, which operates in accordance with a program stored in a memory. At least some of the functions of the information processing apparatus 310 shown in FIG. 3 may be implemented by dedicated hardware.

The storage unit 1102 stores various kinds of data in addition to programs to be executed by the processing unit 1101. In the example shown in FIG. 10, databases (DB) 1111 and 1112 are shown as data stored in the storage unit 1102. The DB 1111 is a DB in which pieces of information of leading vehicle candidates which are registered in advance and are to be requested to do following travel are registered. The information of a leading vehicle candidate may be the information of the driver of a leading vehicle, for example, the number of experiences of leading travel in following travel or an evaluation by the user of a following vehicle. Alternatively, the information of a leading vehicle candidate may be information concerning the vehicle specifications of a leading vehicle. The information concerning vehicle specifications may be the maximum speed, the maximum acceleration, the maximum braking force, the maximum steering angle, the minimum turning radius of a leading vehicle, whether the leading vehicle can do autonomous travel on an expressway, the total length, the width, and the height, or fuel information. Also, the information of a leading vehicle candidate may be travel information of a vehicle representing the current point of the vehicle, the scheduled moving course of the vehicle, and the like. The DB 1112 is a DB in which pieces of information of a following vehicle are registered. The information of a following vehicle may be the information of the vehicle specifications of a following vehicle. The information of a following vehicle may be stored in the DB 1112 in linkage with the account of a user who wants following travel. Note that in this specification, autonomous travel is automated travel in which at least some of user operations for driving a vehicle are automated, and is different from following travel of following a leading vehicle and normal travel in which a user performs normal manual driving.

A case in which the information processing apparatus 310 generates, based on a departure point and a destination desired by the user of the following vehicle 202, a travel plan to perform following travel in at least a part between the departure point and the destination will be described below. Note that the departure point desired by the user may be the current position of the following vehicle 202 or a position selected on an online map by the user. In this case, the following vehicle 202 may be a vehicle owned by the user or a vehicle temporarily used by the user. The leading vehicle 201 is not particularly limited. The leading vehicle 201 may be, for example, a vehicle (to be referred to as a delivery vehicle hereinafter) driven by a logistics infrastructure distributor such as a delivery service company or a mail transport, which performs leading while delivering an article, or a vehicle (to be referred to as a specialized vehicle hereinafter) driven by a specialized driver who performs only leading.

In this specification, the starting point and the end point of following travel will be referred to as takeover points. Also, the starting point of following travel will be referred to as a meeting point. The meeting point may include a departure point, and a travel plan from a departure point to a destination may include a plurality of meeting points from which following travel to different leading vehicles 201 starts.

As shown in FIG. 3, the information processing apparatus 310 according to this embodiment includes an obtaining unit 311, a course search unit 312, a vehicle search unit 313, a plan generation unit 314, and a transmission unit 315. Note that a reward calculation unit 316 is a functional unit used to pay a reward from the following vehicle 202 to the leading vehicle 201, and details will be described later.

The obtaining unit 311 obtains a departure point and a destination desired by the user of the following vehicle. The terminal 320 includes an obtaining unit like a touch screen that obtains a departure point and a destination desired by the user of the following vehicle 202. The obtaining unit 311 can obtain the departure point and the destination that the user who wants following travel inputs to the terminal 320. The obtaining unit 311 can also obtain another information concerning following travel. For example, the obtaining unit 311 can obtain other conditions concerning a travel plan. Examples of the conditions of the travel plan are a condition concerning a meeting point or a takeover point, a condition concerning a wait time until meeting, a condition concerning the leading vehicle 201, and whether to travel an expressway. Other examples of information concerning following travel are the fuel information of the following vehicle 202, information representing whether a person exists in the following vehicle 202, and information representing whether the following vehicle 202 can be manually driven. The information processing apparatus 310 can generate the travel plan of the following vehicle 202 from the departure point to the destination based on the information obtained by the obtaining unit 311.

The condition concerning a meeting point or a takeover point can include, for example, a condition concerning a facility used as a meeting point or a takeover point. The condition concerning a facility used as a meeting point or a takeover point may be a facility genre (for example, a facility type such as a convenience store, a restaurant, a drive-in (roadside station), or a gas station) or a designation of a specific facility. With this arrangement, the user of the following vehicle can easily start following travel from a desired point or end following travel at a desired point.

The condition concerning a wait time until meeting is a condition concerning a wait time to wait for the leading vehicle 201 at a meeting point. For example, this condition may be an upper limit time of standby to wait for the leading vehicle 201. If such a condition is set, a travel plan is generated so as to follow the leading vehicle 201 that arrives within the upper limit time after the arrival of the following vehicle 202.

The condition concerning the leading vehicle may be, for example, a condition concerning the driver of the leading vehicle or the category of the leading vehicle. The condition concerning the driver of the leading vehicle may be a designation of a driver, a condition concerning the evaluation of a driver, or a condition concerning the leading experience of a driver. The condition concerning the category of the leading vehicle may be a condition concerning the operator of a leading vehicle (for example, whether a leading vehicle is a delivery vehicle or a specialized vehicle), or a condition of vehicle classification of a leading vehicle (for example, a passenger vehicle, a freight vehicle, or a two-wheeled vehicle). The condition concerning a leading vehicle may be a combination of these.

Examples of the fuel information of the following vehicle 202 are a fuel type, the remaining amount of fuel, and a drivable distance. The information representing whether the following vehicle 202 can be manually driven may represent whether the user of the following vehicle 202 is drunken.

The course search unit 312 generates, based on the information of the departure point and the destination desired by the user and obtained by the obtaining unit 311, a temporary route from the current point of the following vehicle to the destination. The temporary route is used to search for a leading vehicle by the vehicle search unit 313 to be described later and generate a travel plan by the plan generation unit 314. Details will be described later.

The vehicle search unit 313 searches, based on the temporary route generated by the course search unit 312, the candidates of the leading vehicle 201 for the leading vehicle 201 that the following vehicle 202 follows. The search of the leading vehicle 201 that the following vehicle 202 follows is thus performed based on the departure point and the destination. For example, the vehicle search unit 313 can select a specialized vehicle near the current point of the following vehicle 202 from the candidates of the leading vehicle 201. In addition, the vehicle search unit 313 can select, from the candidates of the leading vehicle 201, a delivery vehicle traveling near the current time from near the current point of the following vehicle 202 toward the destination.

In this specification, regardless of the course of current travel, a specialized vehicle can go to the departure point of following travel to pick up the following vehicle 202 and lead the following vehicle 202 to the end point of the following travel. On the other hand, a delivery vehicle travels along a predetermined travel course and can lead the following vehicle 202 along the travel course from the departure point to the end point of following travel. However, within a predetermined distance from the predetermined travel course, the delivery vehicle can go to the departure point of following travel deviated from the predetermined travel course to pick up the following vehicle 202 and lead the following vehicle 202 to the end point of the following travel deviated from the predetermined travel course. Note that the type of the leading vehicle 201 is not particularly limited. A private car may lead the following vehicle 202 like a specialized vehicle, or a private car traveling along a predetermined travel course may lead the following vehicle 202 like a delivery vehicle.

The vehicle search unit 313 refers to the information of leading vehicle candidates registered in the DB 1111, thereby searching for the leading vehicle 201 in accordance with the condition concerning a travel plan or following travel obtained by the obtaining unit 311. For example, the vehicle search unit 313 can obtain, from the DB 1111, travel information representing the current point or the schedule of the moving course of a vehicle registered as a candidate of the leading vehicle 201. For a candidate of the leading vehicle 201, which is a delivery vehicle, the vehicle search unit 313 may obtain travel information such as a route and time to perform delivery. Table 1 shows an example of the information of leading vehicle candidates stored in the DB 1111. In Tables 1 and 2, specifications representing the motion performance of a vehicle, the information of a driver, travel information concerning a travel course, and other conditions are stored as the information of leading vehicle candidates. Note that Table 1 shows the information of delivery vehicles, and Table 2 shows the information of specialized vehicles.

TABLE 1

| | | | | Driver | | | | | |
|---|---|---|---|---|---|---|---|---|---|
| | Vehicle specifications | | | information | | Travel information | | | |
| | | Maximum | Maximum | Number | | | Scheduled | Lead | |
| Vehicle | Maximum | braking | steering | of times | | | delivery | accepting | Other |
| ID | acceleration | force | angle | of lead | Evaluation | Route | time | area | conditions |
| 501 | 1.5 | 28.0 | 90° | 4 | stars 4.4 | office A ⇒ | office A 8:00 via | following travel | nothing |
| | m/s² | m/(70 km/h) | | | | via point B ⇒ | point B | starting point or | |
| | | | | | | via point C ⇒ | 8:30 scheduled | takeover point | |
| | | | | | | via point D ⇒ | delivery time | is set within a | |
| | | | | | | via point A | 5 min via point C | radius of 100 m | |
| | | | | | | | 9:00 scheduled | along travel | |
| | | | | | | | delivery time | plans | |
| | | | | | | | 5 min . . . | | |
| 502 | . . . | . . . | . . . | . . . | . . . | . . . | . . . | . . . | . . . |
| 503 | . . . | | | | | | | | |
| . . . | | | | | | | | | |

TABLE 2

| | | | | Driver | | | |
|---|---|---|---|---|---|---|---|
| | Vehicle specifications | | | information | | Travel | |
| | | Maximum | Maximum | Number | | information | |
| Vehicle | Maximum | braking | steering | of times | | Leadable | Other |
| ID | acceleration | force | angle | of lead | Evaluation | area | conditions |
| 503 | 1.5 | 28.0 | 90° | 3 | stars 4.4 | departing | nothing |
| | m/s² | m/(70 km/h) | | | | point and | |
| | | | | | | destination | |
| | | | | | | are within | |
| | | | | | | Utsunomiya | |
| 505 | . . . | . . . | . . . | . . . | . . . | Radius | |
| | | | | | | of ◯ m | |
| | | | | | | from | |
| | | | | | | station X | |
| 504 | . . . | | | | | | |
| . . . | | | | | | | |

Furthermore, the vehicle search unit 313 may search for the leading vehicle 201 in consideration of the vehicle size of the leading vehicle 201. For example, the vehicle search unit 313 can search for the leading vehicle 201 having a size that allows the vehicle to enter the starting point and the end point of following travel.

Next, based on the information obtained by the obtaining unit 311, the plan generation unit 314 generates a travel plan including, in at least a part between the departure point and the destination, a section of following travel in which the following vehicle 202 follows the leading vehicle 201 found by the vehicle search unit 313.

The plan generation unit 314 refers to the condition concerning a meeting point to the leading vehicle obtained by the obtaining unit 311, thereby generating a travel plan so as to start following travel at a point desired by the user of the following vehicle 202. In addition, the plan generation unit 314 refers to the condition concerning a meeting point to the leading vehicle obtained by the obtaining unit 311, thereby generating a travel plan so as to start following travel in a facility of a type desired by the user of the following vehicle 202.

Following travel need not be performed in the whole section between the departure point and the destination. The plan generation unit 314 may generate a travel plan further including, in at least a part between the departure point and the destination, a section of autonomous travel in which the following vehicle 202 solely performs automated travel or a section of manual travel in which the following vehicle 202 solely performs manual travel. According to this arrangement, since the section of lead by the leading vehicle 201 can be made short, the leading vehicle 201 can easily be found by the search. For example, if the following vehicle 202 is a vehicle capable of performing autonomous travel on a road of a specific type (for example, an expressway), the plan generation unit 314 may generate a travel plan to perform autonomous travel on a road of the specific type. In the travel plan, autonomous travel and following travel may be switched halfway in this way.

Also, if manual driving of the following vehicle 202 is possible, the plan generation unit 314 may generate a travel plan including, in at least a part between the departure point and the destination, a section of manual travel in which the user manually drives the following vehicle 202. For example, if the leading vehicle 201 approaching the departure point cannot be found, the user can move the following vehicle 202 to the vicinity of the leading vehicle 201 by manual driving and then start following travel. In this case, the plan generation unit 314 can switch whether to include the section of manual travel in the travel plan or not depending on whether the user of the following vehicle 202 can manually drive the following vehicle 202. For example, if the user of the following vehicle 202 has drunk alcohol, the plan generation unit 314 can determine that the user cannot manually drive the following vehicle 202.

In addition, the following vehicle 202 may sequentially follow a plurality of leading vehicles 201. That is, the plan generation unit 314 can generate a travel plan including a section of first following travel in which the following vehicle 202 follows a first leading vehicle and a section of second following travel in which the following vehicle 202 follows a second leading vehicle. According to this arrangement, since the section of lead by one leading vehicle 201 can be made short, the leading vehicle 201 can easily be found by the search.

As a detailed example, the following vehicle 202 can travel following the first leading vehicle from the starting point that is the point to start the first following travel to a takeover point that is a point to end the first following travel. In addition, the following vehicle can travel following the second leading vehicle from the takeover point to the next point to end the following travel. In this way, the end point of the section of the first following travel and the starting point of the section of the second following travel may exist at the same point. According to this arrangement, the leading vehicle 201 can be taken over without performing manual driving by the user of the following vehicle 202. In this case, the vehicle search unit 313 can select, for example, a specialized vehicle existing near the starting point from the candidates of the leading vehicle 201, and can select, for example, a delivery vehicle that travels from the takeover point toward the destination near the scheduled time of arrival at the takeover point.

The meeting point to start following travel is not particularly limited. When a space available for parking is set as the meeting point, the following vehicle 202 or the leading vehicle 201 can easily wait for the other at the meeting point, and the following vehicle 202 and the leading vehicle 201 can easily meet. Hence, a space available for parking or stop other than the main lane of the road where vehicles travel can be set as the meeting point. Detailed examples of the meeting point are a parking area and a road shoulder or a roadside strip of a road.

As described above, the obtaining unit 311 can obtain the condition concerning the meeting point to the leading vehicle. In this case, the plan generation unit 314 can generate a travel plan so as to start following travel at the meeting point complying with the condition. For example, a store of a predetermined genre may be selected as the condition concerning the meeting point. In this case, the plan generation unit 314 can generate a travel plan in which the meeting point is the parking area of a store of the selected genre.

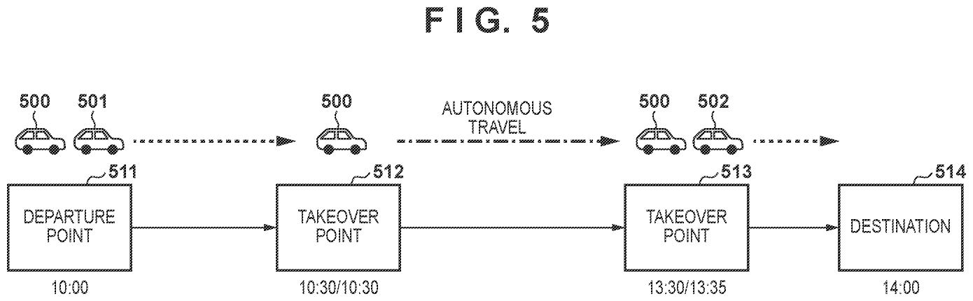

FIG. 5 shows an example of a travel plan generated by the plan generation unit 314. In this travel plan, a following vehicle 500 meets a leading vehicle 501 at a departure point 511 at 10:00, follows the leading vehicle 501, and arrives at a takeover point 512 at 10:30. The section from the takeover point 512 to a takeover point 513 is an expressway where autonomous travel is possible. For this reason, the following vehicle 500 departs from the takeover point 512 by autonomous travel at 10:30 and arrives at the takeover point 513 at 13:30. After that, the following vehicle 500 waits for the arrival of a leading vehicle 502, departs from the takeover point 513 following the leading vehicle 502 at 13:35, and arrives at a destination 514 at 14:00.

The takeover point to switch between autonomous travel and following travel is not particularly limited. When the entrance or exit of a road (for example, an expressway) to perform autonomous travel is set to the takeover point, it is easy to start or end lead by the leading vehicle 201 or start or end autonomous travel. For this reason, in the embodiment, the plan generation unit 314 generates a travel plan in which switching between autonomous travel and following travel is done at the entrance or exit of an expressway with a space available for parking (for example, a smart IC with a rest place). According to this arrangement, following travel and autonomous travel can be switched without performing manual driving by the user of the following vehicle.

If manual driving of the following vehicle 202 is possible, a point available for parking and located near the entrance or exit of the road where autonomous travel is performed can be set as the takeover point to start or end following travel. For example, the following vehicle 202 can follow the leading vehicle 201 up to the takeover point, move from the takeover point to the entrance of an expressway in accordance with manual driving of the user, and perform autonomous travel from the entrance of the expressway.

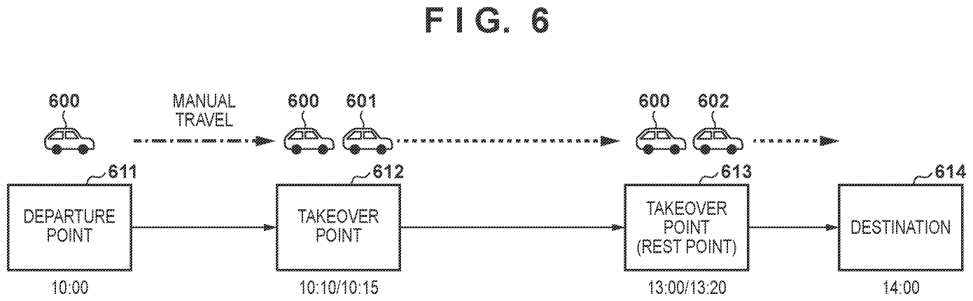

FIG. 6 also shows an example of a travel plan generated by the plan generation unit 314. In this travel plan, a following vehicle 600 departs from a departure point 611 by manual driving at 10:00, and arrives at a takeover point 612 at 10:10. After that, the following vehicle 600 waits for the arrival of a leading vehicle 601, departs from the takeover point 612 following the leading vehicle 601 at 10:15, and arrives at a takeover point 613 at 13:00. Since lead by the leading vehicle 601 ends at the takeover point 613, the following vehicle 600 waits for the arrival of a leading vehicle 602. The following vehicle 600 departs from the takeover point 613 following the leading vehicle 602 at 13:20, and arrives at a destination 614 at 14:00.

The transmission unit 315 can transmit the travel plan generated by the plan generation unit 314 to the terminal 320 of the following vehicle 202. The transmission unit 315 can also transmit the travel plan generated by the plan generation unit 314 to the terminal 330 of the leading vehicle 201, as will be described later.

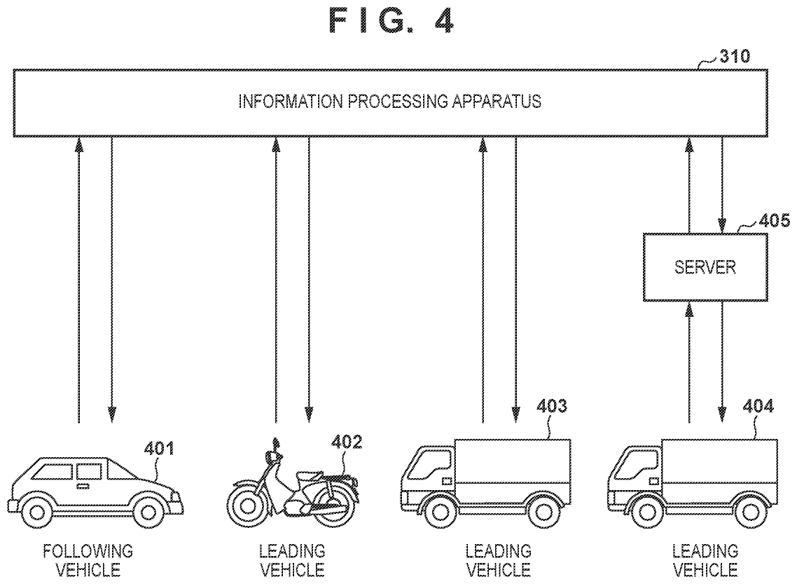

As described above, the vehicle search unit 313 can search for the leading vehicle 201 based on the travel information representing the current point or the scheduled moving course concerning each candidate of the leading vehicle 201 traveling each place. FIG. 4 shows an example of communication processing performed by the information processing apparatus 310 to collect travel information for the candidates of the leading vehicle 201.

Referring to FIG. 4, the information processing apparatus 310 transmits/receives information to/from a following vehicle 401 or the terminal 320 used by the user of the following vehicle, thereby obtaining pieces of information such as a departure point and a destination. Also, the information processing apparatus 310 transmits/receives information to/from vehicles 402 and 403 that are leading vehicle candidates or the terminals 330 used by the users of the vehicles, thereby obtaining travel information concerning the vehicles 402 and 403. In FIG. 4, the vehicle 402 is a specialized vehicle, the vehicle 403 is a delivery vehicle, and these transmit various kinds of information including a current point and a scheduled moving course to the information processing apparatus 310. A vehicle 404 is a delivery vehicle, too. The vehicle 404 travels in accordance with an instruction from a server 405 that manages the vehicle 404, and its travel information is managed by the server 405. In this case, the information processing apparatus 310 can obtain travel information concerning the vehicle 404 that is a leading vehicle candidate from the server 405. After that, the information processing apparatus 310 can transmit a generated travel plan to the following vehicle 401, the vehicles 402 and 403 selected as leading vehicles, and the server 405 that manages the vehicle 404 selected as a leading vehicle.

(Example of Processing)

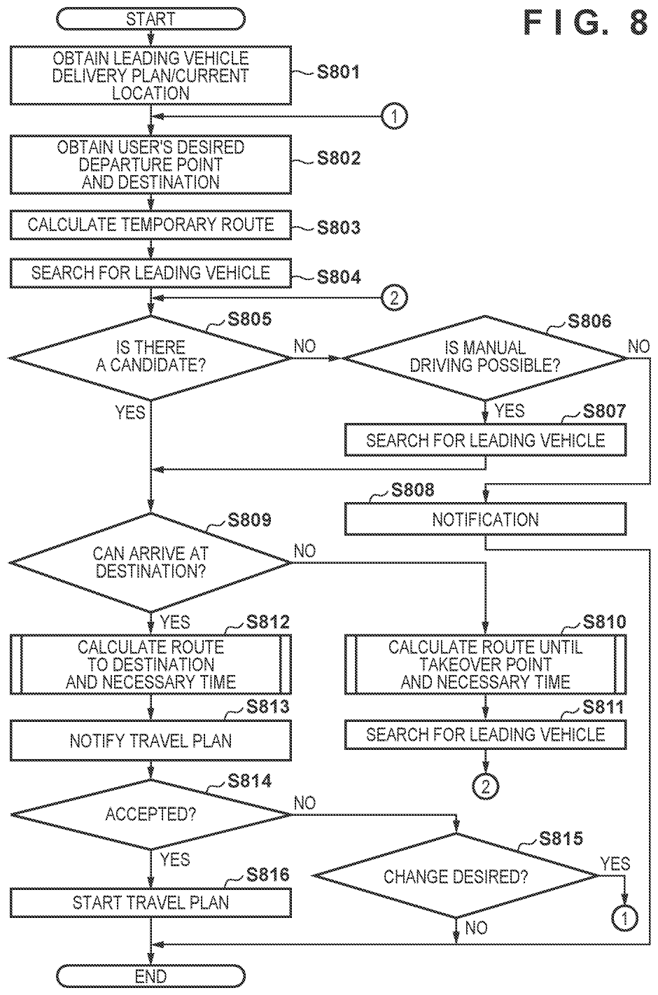

FIG. 8 is a flowchart showing an example of processing of generating a travel plan, which is performed by the information processing apparatus 310 according to this embodiment. In step S801, the vehicle search unit 313 obtains travel information including the current point and the scheduled moving course of each leading vehicle candidate traveling each place and stores the travel information in the DB 1111. In step S802, the obtaining unit 311 obtains information including a departure point and a destination desired by the user of the following vehicle 202 and input by the user via the terminal 320.

In step S803, the course search unit 312 generates a temporary route from the departure point to the destination of the following vehicle 202 based on the information obtained by the obtaining unit 311. The temporary route generation method is not particularly limited, and, for example, the shortest course from the departure point to the destination can be employed as the temporary route.

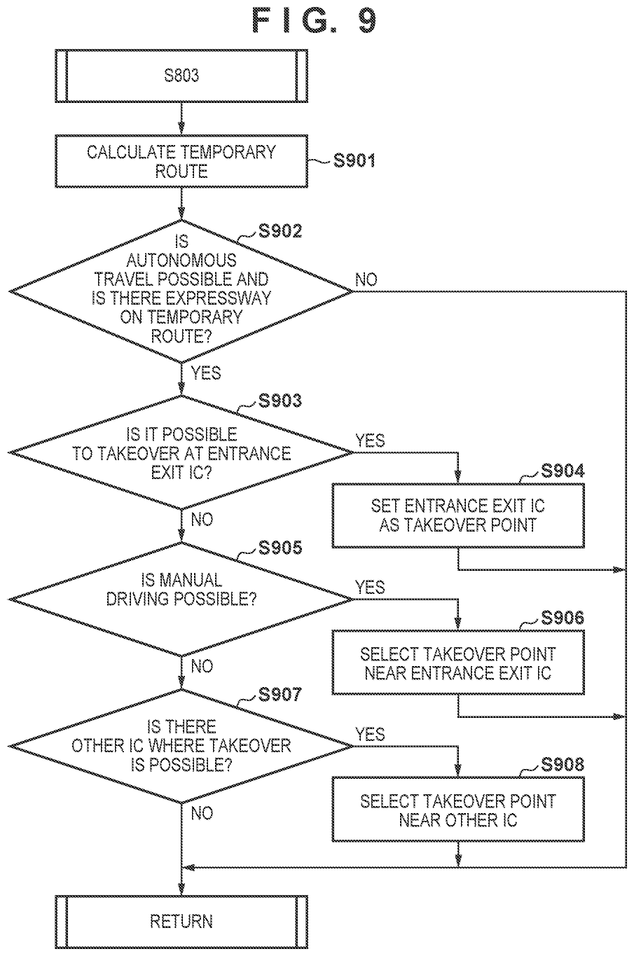

On the other hand, the course search unit 312 can set a takeover point such that autonomous travel and following travel can easily be switched when performing autonomous travel in the midway. In this case, in step S803, the course search unit 312 can set a temporary route and a takeover point in accordance with a flowchart shown in FIG. 9. A case in which autonomous travel is performed on an expressway will be described here.

In step S901, the course search unit 312 generates a temporary route from the departure point to the destination of the following vehicle 202. In step S902, the course search unit 312 determines whether the following vehicle 202 can autonomously travel, and a road (expressway) on which autonomous travel can be performed exists on the temporary route. If the following vehicle can autonomously travel, and an expressway exists on the temporary route, the process advances to step S903. Otherwise, the processing shown in FIG. 9 is ended.

In step S903, the course search unit 312 determines whether it is possible to do takeover between following travel and autonomous travel at the entrance IC and the exit IC to the expressway on the temporary route. If the entrance IC and the exit IC each have a space available for parking (for example, if each IC is a smart IC), the course search unit 312 can determine that the takeover is possible. If takeover is possible, the process advances to step S904. In this case, the course search unit 312 sets the entrance IC and the exit IC to takeover point candidates. The processing shown in FIG. 9 is thus ended. On the other hand, if takeover is not possible at least at one of the entrance IC and the exit IC, the process advances to step S905. In this case, the course search unit 312 can set an entrance IC or an exit IC at which takeover is possible to a takeover point candidate.

In step S905, the course search unit 312 determines whether manual driving of the following vehicle 202 is possible. If manual driving is possible, the process advances to step S906. In this case, the course search unit 312 sets a point such as a parking area, at which takeover is possible and which exists near the entrance IC and the exit IC where takeover is not possible, to a takeover point candidate. The processing shown in FIG. 9 is thus ended. If manual driving is not possible, the process advances to step S907.

In step S907, the course search unit 312 determines whether an IC where takeover is possible exists in an expressway section on the temporary route. The course search unit 312 may determine whether an IC where takeover is possible exists near the entrance IC and the exit IC on the temporary route. If an IC where takeover is possible exists, the process advances to step S908. In step S908, the course search unit 312 corrects the temporary route such that the entrance IC or the exit IC on the temporary route calculated in step S901 is changed to the IC where takeover is possible, and sets the entrance IC and the exit IC after the change to takeover point candidates. The processing shown in FIG. 9 is thus ended. Even if it is determined in step S907 that an IC where takeover is possible does not exist, the processing shown in FIG. 9 is ended. In this case, a travel plan can be generated such that following travel is performed even on the expressway.

According to the method shown in FIG. 9, takeover between following travel and autonomous travel can be performed at an entrance IC and an exit IC each including a space available for parking. If manual driving is possible, takeover between following travel and autonomous travel can be performed near the entrance IC and the exit IC.

Next, a travel plan from the departure point to the destination is generated by the processes of steps S804 to S812. Note that if an autonomous travel section is set in step S803, a travel plan for each section excluding the autonomous travel section can be generated.

In step S804, based on the travel information of each leading vehicle candidate obtained in step S801 and the temporary route generated in step S803, the vehicle search unit 313 searches for a candidate of the leading vehicle 201 that the following vehicle 202 can follow. As described above, the vehicle search unit 313 can search for a candidate of the leading vehicle 201 located near the departure point or a candidate of the leading vehicle 201 moving from the departure point toward the destination. If a candidate of the leading vehicle 201 is found, the process advances from step S805 to step S809. If a candidate is not found, the process advances from step S805 to step S806.

In step S806, the plan generation unit 314 determines whether manual driving of the following vehicle 202 is possible. If manual driving is possible, the following vehicle 202 is moved by manual driving and made to meet the leading vehicle 201 at another point. If manual driving of the following vehicle 202 is possible, the process advances to step S807. If manual driving of the following vehicle 202 is not possible, the process advances to step S808. Note that to make the manual driving section short, if a point (for example, a parking area) where the following vehicle can meet the leading vehicle 201 exists within a predetermined range from the position (the departure point or a takeover point) of the following vehicle 202, the process may advance from step S806 to step S807.

In step S807, the plan generation unit 314 sets a point which is located near the position (the departure point or a takeover point) of the following vehicle 202 and at which the following vehicle can meet the leading vehicle 201 to a takeover point. In addition, the vehicle search unit 313 calculates a manual driving route and a necessary time up to the takeover point. In step S808, the vehicle search unit 313 searches for a candidate of the leading vehicle 201 existing near the takeover point set in step S807 or moving from the takeover point toward the destination near the scheduled arrival time of the following vehicle 202 at the takeover point, as in step S804. Note that if a candidate of the leading vehicle 201 is not found, the vehicle search unit 313 may calculate a manual driving route and a necessary time up to the destination. After that, the process returns to step S805. On the other hand, in step S808, the vehicle search unit 313 transmits a message representing that the leading vehicle 201 cannot be found to the terminal 320 of the following vehicle 202, and ends the processing. In step S809, the plan generation unit 314 determines whether the following vehicle 202 can arrive at the destination by following the candidate of the leading vehicle 201 found in step S804 or S807 immediately before. For example, if the candidate of the leading vehicle 201 moves to the destination or the vicinity thereof, it can be determined that the following vehicle 202 can arrive at the destination. As a detailed example, if the candidate of the leading vehicle 201 is a delivery vehicle, and the destination is located within a predetermined range from the scheduled delivery route of the delivery vehicle, it can be determined that the following vehicle 202 can arrive at the destination. If the candidate of the leading vehicle 201 is a specialized vehicle, and the destination is located within a leadable area set in advance for each vehicle, it can be determined that the following vehicle 202 can arrive at the destination. If the following vehicle 202 can arrive at the destination, the process advances to step S812. If the following vehicle 202 cannot arrive at the destination, the process advances to step S810.

In step S810, the plan generation unit 314 sets a point at which the following vehicle 202 can arrive by following travel and meet another leading vehicle 201 to a takeover point. For example, the plan generation unit 314 can set a parking area that is closest to the destination and is located within a predetermined range from the scheduled delivery route of the delivery vehicle that is the candidate of the leading vehicle 201 to a takeover point. Also, the plan generation unit 314 can set a parking area that is closest to the destination and is located within the leadable area of the specialized vehicle that is the candidate of the leading vehicle 201 to a takeover point. The plan generation unit 314 calculates a following travel route and a necessary time up to the takeover point when following the leading vehicle 201 found in step S804 or S807 described above. In step S811, the vehicle search unit 313 searches for a candidate of the leading vehicle 201 existing near the takeover point set in step S810 or moving from the takeover point toward the destination near the scheduled arrival time of the following vehicle 202 at the takeover point, as in step S804. After that, the process returns to step S805.

In step S812, the plan generation unit 314 calculates a following travel route and a necessary time up to the destination when following the leading vehicle 201 found in step S804, S807, or S811 immediately before. The travel plan from the departure point to the destination can be obtained by the processing so far. The travel plan can include the travel route and travel time of following travel calculated in step S810 or S812. In addition, the travel plan can include the travel route and travel time of autonomous travel or manual travel calculated in step S803 or S807.

Note that a plurality of travel plans may be generated for one combination of a departure point and a destination. For example, in step S804, S807, or S811, the vehicle search unit 313 may search for a plurality of candidates of the leading vehicle 201. In this case, a travel plan corresponding to each candidate of the leading vehicle 201 is obtained. Alternatively, in step S803, the course search unit 312 may generate a plurality of temporary routes. In this case, a travel plan corresponding to each temporary route is obtained.

In step S813, the plan generation unit 314 transmits the generated travel plan to the user of the following vehicle 202. For example, the plan generation unit 314 transmits, via the transmission unit 315, information representing the travel plan to the terminal 320 used by the user of the following vehicle 202. The terminal 320 can display the travel route and the necessary time from the departure point to the destination in accordance with the information. Additionally, in accordance with the information, the terminal 320 can display the following travel section included in the section from the departure point to the destination such that it can be discriminated from another travel section (for example, an autonomous travel section or a manual travel section). Also, the terminal 320 may display information (for example, the position of a takeover point and the name or type of a facility selected as the takeover point) concerning each takeover point. If it is necessary to wait for the leading vehicle 201 at a takeover point, the terminal 320 can display a wait time.

In step S814, the plan generation unit 314 determines whether the user of the following vehicle 202 has accepted the transmitted travel course. For example, the plan generation unit 314 can obtain, from the terminal 320, a user instruction representing whether to accept the travel plan displayed on the terminal 320. The terminal 320 may display a plurality of travel plans. In this case, the plan generation unit 314 can obtain a user instruction representing a travel plan to be accepted. If the travel plan is not accepted, the process advances to step S815. If the travel plan is accepted, the process advances to step S816.

In step S815, the plan generation unit 314 determines whether the user of the following vehicle 202 desires a change of the travel plan. If the user desires a change, the process returns to step S802. For example, the plan generation unit 314 can obtain, from the terminal 320, a user instruction representing whether to desire a change of the travel plan displayed on the terminal 320. At this time, the plan generation unit 314 can obtain the contents of the change desired by the user from the terminal 320. As a detailed example, the user can input, to the terminal 320, a user input representing that manual driving is performed in a specific section, a user input representing that the vehicle follows a specialized vehicle in a specific section, or a user input for changing a relay point. In this case, it is possible to set a manual driving section, search for a candidate of the leading vehicle 201, or set a relay point based on a condition according to the user input. Note that if the search of the leading vehicle 201 is unnecessary, as in a case in which the final following driving section is changed to a manual driving section, the process may advance to step S816 after the travel plan is changed by the plan generation unit 314.

In step S816, the plan generation unit 314 starts the travel plan based on the travel plan accepted by the user of the following vehicle 202. For example, to request dispatch of the leading vehicle 201, the plan generation unit 314 can make a notification to the user of the leading vehicle 201 or the server that manages the travel of the leading vehicle 201. In addition, the plan generation unit 314 can make a notification to the following vehicle 202 such that it performs following travel and autonomous travel according to the travel plan. Also, the plan generation unit 314 may notify the following vehicle 202 of the wait time until the arrival of the leading vehicle 201.

According to the flowchart shown in FIG. 8, the travel plan from the departure point to the destination is generated. According to the processing shown in FIG. 8, if it is not possible to perform following travel to the destination by following one leading vehicle, a takeover point is set between the departure point and the destination, and the travel plan of following travel (or manual travel) from the departure point to the takeover point is generated. Next, if it is not possible to perform following travel from the takeover point to the destination by following one leading vehicle, the next takeover point is set, and the travel plan of following travel (or manual travel) from the preceding takeover point to the next takeover point is generated. In this way, the travel plan from the departure point to the destination is generated by repeating the processing for the course between the takeover points.

With this arrangement, it is possible to decrease the sections of manual travel when the following vehicle 202 moves from the departure point to the destination, or the following vehicle 202 can move by automated travel in the whole section from the departure point to the destination. In particular, even in a case in which autonomous travel is performed in a section such as an expressway where autonomous travel is possible, following travel is further performed in a section other than the expressway, so that the sections of manual travel can be decreased.

### Second Embodiment

In a vehicle following travel system according to the second embodiment, information representing a section of following travel is transmitted to a terminal used by the user of a leading vehicle, thereby facilitating meeting of the leading vehicle with a following vehicle. The vehicle following travel system according to the second embodiment can have an arrangement similar to that in the first embodiment, and can perform similar processing. For example, the vehicle following travel system according to the second embodiment may include an information processing apparatus 310, a terminal 320, and a terminal 330 shown in FIG. 3. In addition, the information processing apparatus 310 can perform processing similar to the flowchart shown in FIG. 8. Differences from the first embodiment will be described below.

In this embodiment, a transmission unit 315 can transmit information representing a section of following travel to the terminal 330 used by the user of a leading vehicle 201. In this case, a display unit such as a display provided in the terminal 330 can obtain and display information representing a section of following travel, which is at least a part of the section between a departure point and a destination desired by the user of a following vehicle 202. In this way, the terminal 330 can present the section of following travel to the user of the leading vehicle 201. According to this arrangement, before the start of following travel, the leading vehicle 201 can know details of the following travel to be performed. The information representing the section of following travel may include information representing the start time or end time of following travel, or the following travel time.

In particular, the information representing the section of following travel can include the information of a point to start following travel. With this arrangement, the leading vehicle 201 and the following vehicle 202 can easily meet at the point to start following travel. For example, the user of the leading vehicle 201 drives the leading vehicle 201 in accordance with the information of the point to start following travel, thereby arriving at the point to start following travel and waiting for the following vehicle 202. The transmission unit 315 may transmit the information of the point to start following travel (for example, the name of a parking area or the genre of a store) to the terminal 330.

The transmission unit 315 may further transmit information representing the current position of the following vehicle 202 or the arrival time of the following vehicle 202 at the point to start following travel to the terminal 330 used by the user of the leading vehicle 201. According to this arrangement, the user of the leading vehicle 201 can grasp the arrival schedule of the following vehicle 202. An instruction unit of the terminal 330 that has received these pieces of information can present, via, for example, the display unit, an instruction for meeting the following vehicle 202 to the user of the leading vehicle 201.

Note that the transmission unit 315 may transmit the information representing the section of following travel to the terminal 320 used by the user of the following vehicle 202. In this case, a display unit such as a display provided in the terminal 320 can obtain and display information representing a section of following travel, which is at least a part of the section between a departure point and a destination desired by the user of the following vehicle 202. In this embodiment, the information representing the section of following travel is shared by an information processing apparatus used by the user of the leading vehicle. With this arrangement, before the start of following travel, the following vehicle 202 can know details of the following travel to be performed. The transmission unit 315 may further transmit information representing the current position of the leading vehicle 201 or the arrival time of the leading vehicle 201 at the point to start following travel to the terminal 320 used by the user of the following vehicle 202. According to this arrangement, the user of the following vehicle 202 can grasp the arrival schedule of the leading vehicle 201.

These processes can be performed by the transmission unit 315 in step S816 based on a generated travel plan.

The transmission unit 315 may further receive a response from the terminal 330 of the leading vehicle 201 or the server that manages the travel of the leading vehicle 201 to the transmitted information representing the section of following travel. For example, the transmission unit 315 may receive an input of the user of the leading vehicle 201 or a response from the server that manages the travel of the leading vehicle 201, which represents whether to accept to perform lead of the presented following travel. In this arrangement, in step S816, a plan generation unit 314 can start the travel plan in accordance with a response for accepting to perform lead. On the other hand, the plan generation unit 314 can regenerate a travel plan in accordance with a response not to accept to perform lead. Note that in step S804, S807, or S811, the transmission unit 315 may inquire of the terminal of a candidate of the leading vehicle 201 found by a vehicle search unit 313 or a server that manages the travel of the leading vehicle about whether to accept to perform lead of following travel. In this case, the plan generation unit 314 can generate a travel plan including the section of following travel in which the leading vehicle 201 that has accepted lead is followed.

### Third Embodiment

A following vehicle that has performed following travel can pay a reward to a leading vehicle. For example, in the first embodiment, the user of the following vehicle that desires following travel can request the leading vehicle to do following travel via an application along a generated travel plan, and perform following travel. In this case, the user of the following vehicle can pay a reward for the lead in the following travel to the leading vehicle.

In a vehicle following travel system according to the third embodiment, in following travel according to a travel plan, a reward to be paid from the following vehicle to the leading vehicle is calculated. According to this arrangement, the user of the leading vehicle or the following vehicle can easily grasp the reward for following travel. For example, before the start of travel according to a travel plan, the user of the following vehicle can confirm the reward amount. The user of the leading vehicle can also confirm the reward amount and judge whether to perform lead of following travel. The vehicle following travel system according to the third embodiment can have an arrangement similar to that in the first embodiment, and can perform similar processing. For example, the vehicle following travel system according to the third embodiment may include an information processing apparatus 310, a terminal 320, and a terminal 330 shown in FIG. 3. In addition, the information processing apparatus 310 can perform processing similar to the flowchart shown in FIG. 8. Differences from the first embodiment will be described below.

In this embodiment, the information processing apparatus 310 includes a reward calculation unit 316. The reward calculation unit 316 can calculate a reward for following travel from a following vehicle 202 to a leading vehicle 201 based on a travel plan generated by a plan generation unit 314. For example, the reward calculation unit 316 can calculate a reward based on the distance of a section of following travel. Alternatively, the reward calculation unit 316 may calculate a reward in accordance with the settings of the leading vehicle 201. For example, the reward calculation unit 316 can calculate a reward based on the operator (for example, a delivery vehicle or a specialized vehicle) of the leading vehicle 201, the vehicle classification of the leading vehicle 201, or the request of the user of the leading vehicle 201. The leading vehicle 201 that is a delivery vehicle can perform lead of following travel while delivering along a predetermined route. For this reason, the route of following travel by the following vehicle 202 may be limited, and a reward requested by the delivery vehicle may be small. On the other hand, the leading vehicle 201 that is a specialized vehicle can perform lead of following travel based on a speed and route desired by the user of the following vehicle 202. For this reason, the necessary time of following travel by the following vehicle 202 may be short, but a reward requested by the specialized vehicle may be larger. The reward may be varied in accordance with a time zone or the ratio of the number of users who want to follow to the number of leadable vehicles. For example, if the number of users who want to follow is large relative to the number of leadable vehicles, the reward can be set high. If the number of users who want to follow is small, the reward can be set low.

As described in the first embodiment, the travel plan may include a plurality of sections of following travel in which the following vehicle follows different leading vehicles. The reward calculation unit 316 can calculate a reward from the following vehicle to each leading vehicle. For example, the reward calculation unit 316 can calculate a reward to a first leading vehicle in accordance with the distance of a first following section in which the following vehicle follows the first leading vehicle, and calculate a reward to a second leading vehicle in accordance with the distance of a second following section in which the following vehicle follows the second leading vehicle.

The section of following travel included in the travel plan may include a toll road. In this case, the toll of the toll road requested for the following vehicle 202 may be paid not by the following vehicle 202 but by the leading vehicle 201. In this case, since the user of the following vehicle 202 need not pay the toll in the tollgate of the toll road, the convenience improves. In this case, the following vehicle 202 can pay the toll of the toll road to the leading vehicle 201. In an embodiment, the reward from the following vehicle 202 to the leading vehicle 201, which is calculated by the reward calculation unit 316, can include the toll of a toll road to be passed by the following vehicle 202 in the travel plan.

The travel plan may include energy supply to the following vehicle 202 in a facility (for example, an energy supply facility such as a gas station) used to extend the drivable distance. In this case as well, the fee of energy supply requested for the following vehicle 202 may be paid not by the following vehicle 202 but by the leading vehicle 201. In this case, since the user of the following vehicle 202 need not pay the fee in the energy supply facility, the convenience improves. In this case, the following vehicle 202 can pay the fee of energy supply to the leading vehicle 201. In an embodiment, the reward from the following vehicle 202 to the leading vehicle 201, which is calculated by the reward calculation unit 316, can include the fee of energy supplied to the following vehicle 202 in the travel plan.

Processing of calculating the reward can be performed by the reward calculation unit 316 in step S813 based on the generated travel plan. In this case, a transmission unit 315 can transmit the travel plan generated by the plan generation unit 314 and the reward calculated by the reward calculation unit 316 to the user of the following vehicle 202. For example, the transmission unit 315 can transmit information representing the travel plan and the reward to the terminal 320 of the following vehicle 202. Here, the transmission unit 315 may transmit information representing details of the reward to the terminal 320. As a detailed example, the transmission unit 315 may transmit the reward for lead, the toll of the toll road, and the fee of energy supply to the user of the following vehicle 202 such that these can be discriminated. Also, the transmission unit 315 may issue an instruction for performing lead of following travel in accordance with the travel plan to the user of the leading vehicle 201 in accordance with a response from the user of the following vehicle 202. According to this arrangement, the user of the following vehicle 202 can confirm the reward for following travel before the start of the following travel.

Note that the reward calculation unit 316 may calculate a reward to a candidate of the leading vehicle 201 found by the vehicle search unit 313 in step S804, S807, or S811. The transmission unit 315 may then transmit the reward to the terminal of the candidate of the leading vehicle 201 or the server that manages the travel of the leading vehicle and inquire about whether to accept to perform lead of following travel.

As described above, the plan generation unit 314 can calculate a plurality of travel plans. In this case, the reward calculation unit 316 can calculate the reward from the following vehicle 202 to the leading vehicle 201 for each of the plurality of travel plans. The transmission unit 315 can then transmit the plurality of travel plans and rewards to the user of the following vehicle 202 and obtain a user instruction representing a travel plan desired by the user of the following vehicle 202.

Note that the plan generation unit 314 may calculate the travel plan in consideration of a preference of the user of the following vehicle 202 concerning a reward. For example, the user of the following vehicle 202 can select a setting for reducing the reward by preferentially selecting a delivery vehicle as the leading vehicle 201 or a setting for shortening the necessary time by preferentially selecting a specialized vehicle as the leading vehicle 201. Also, the user of the following vehicle 202 can select a setting of actively performing manual travel or a setting of avoiding use of manual travel as much as possible. If the setting of actively performing manual travel is selected, the plan generation unit 314 can preferentially select, as a takeover point, a point where the following vehicle easily meets the leading vehicle 201 such as a delivery vehicle of a low reward such that the reward becomes low. Also, the plan generation unit 314 can generate a plurality of travel plans according to different settings. For example, the plan generation unit 314 may generate a travel plan (for example, a delivery vehicle is preferentially selected) focusing on the reward, a travel plan (for example, a specialized vehicle is preferentially selected) focusing on the speed, and an intermediate travel plan.

Similarly, in step S816, the transmission unit 315 may transmit information representing the section of following travel and the reward to the terminal used by the user of the leading vehicle 201 or the server that manages the travel of the leading vehicle 201. In this case, in accordance with a response from the terminal used by the user of the leading vehicle 201 or the server that manages the travel of the leading vehicle 201, the transmission unit 315 may notify the user of the following vehicle 202 of information representing that the leading vehicle 201 performs lead of following travel. In this way, the transmission unit 315 can obtain, from the terminal used by the user of the leading vehicle 201 or the server that manages the travel of the leading vehicle 201, the notification representing that the leading vehicle 201 accepts to perform lead of following travel. The transmission unit 315 can then notify the following vehicle 202 that the leading vehicle 201 accepts to perform lead of following travel. According to this arrangement, the user of the leading vehicle 201 (the driver or manager of the leading vehicle 201) can confirm the reward for following travel before accepting lead of following travel.

On the other hand, the reward calculation unit 316 may calculate the reward for following travel from the following vehicle 202 to the leading vehicle 201 at the end of following travel or at the time of completion of the travel plan. In this case, the reward calculation unit 316 may obtain information representing an additional reward to the leading vehicle 201, which is designated by the user of the following vehicle 202. With this arrangement, the reward calculation unit 316 can include, in the reward from the following vehicle 202 to the leading vehicle 201, a tip designated by the user of the following vehicle 202 in addition to the reward calculated in accordance with the above-described method.

Additionally, the reward calculation unit 316 may include a payment unit (not shown) that performs reward payment processing from the following vehicle 202 to the leading vehicle 201. With this arrangement, the reward calculated by the reward calculation unit 316 can be automatically paid from the following vehicle 202 to the leading vehicle 201 at the end of following travel or at the time of completion of the travel plan. For this reason, the reward can easily be paid from the following vehicle to the leading vehicle. For example, the user of the following vehicle 202 can register the information of a credit card in the DB 1112. The user of the following vehicle 202 can deposit the reward into the account of the user of the leading vehicle 201 (or the server that manages the travel of the leading vehicle) via an application using the credit card. The payment of the reward from the following vehicle 202 to the leading vehicle 201 may be done by another method.

Note that the type of the reward is not particularly limited. The reward may be a currency or a virtual currency. The reward may be a point that can be exchanged with a currency or a point that cannot be exchanged with a currency.

In addition, the transmission unit 315 may obtain an evaluation for the leading vehicle 201 from the following vehicle 202 at the end of following travel or at the time of completion of the travel plan. If each of a plurality of leading vehicles 201 is followed in the travel plan, the transmission unit 315 can obtain an evaluation for each leading vehicle 201. The evaluation for the leading vehicle 201 may be an evaluation for the driver of the leading vehicle 201. The transmission unit 315 may obtain an evaluation for a course or a takeover point included in the travel plan. The evaluation obtained by the transmission unit 315 can be stored in, for example, the DB 1111. After that, the vehicle search unit 313 can search for a candidate of the leading vehicle 201 in consideration of the evaluation for the leading vehicle 201.

### Fourth Embodiment

In a vehicle following travel system according to the fourth embodiment, a travel plan including a rest is generated. According to this arrangement, a following vehicle can temporarily interrupt travel in accordance with the travel plan, and the user of the following vehicle can take a rest. Particularly, in this embodiment, in consideration of the arrival time of the following vehicle at a takeover point with a rest, a leading vehicle for following travel to be performed after the rest can be searched for. The vehicle following travel system according to the fourth embodiment can have an arrangement similar to that in the first embodiment, and can perform similar processing. For example, the vehicle following travel system according to the fourth embodiment may include an information processing apparatus 310, a terminal 320, and a terminal 330 shown in FIG. 3. In addition, the information processing apparatus 310 can perform processing similar to the flowchart shown in FIG. 8. Differences from the first embodiment will be described below.

In this embodiment, an obtaining unit 311 can obtain a rest condition desired by the user of a following vehicle 202 in addition to a departure point and a destination desired by the user of the following vehicle 202. The rest condition is a condition concerning a rest included in a travel plan, and may be a condition concerning the presence/absence of a rest, the number of rests, a rest interval (for example, every 1 hr, 2 hrs, or 3 hrs), a rest time of each rest (for example, 5 min, 10 min, or 1 hr), or a rest point. The condition concerning a rest point can include a condition concerning a facility used as a rest point. The condition concerning a facility used as a rest point may be a facility genre (for example, a facility type such as a convenience store, a restaurant, a drive-in (roadside station), or a gas station) or a designation of a specific facility. If a plurality of rests are to be taken, the obtaining unit 311 may obtain a condition concerning a different rest point for each rest. With this arrangement, the user of the following vehicle can take a rest at a desired point.

A plan generation unit 314 generates a travel plan that includes a section of following travel in at least a part between the departure point and the destination and further includes a rest complying with a rest condition. The rest may be set at the starting point, a middle point, or the end point of the section of following travel. In addition, the rest may be set at the starting point, a middle point, or the end point of a section of autonomous travel in which the following vehicle 202 solely performs automated travel. Also, the rest may be set at the starting point, a middle point, or the end point of a section of manual travel in which the following vehicle 202 is solely manually driven. For example, a rest can be taken at the starting point of following travel, that is, at a meeting point. According to this arrangement, the user of the following vehicle 202 can wait for the arrival of a leading vehicle 201 of following travel while taking a rest at a rest point (that is, a meeting point) complying with a rest condition. In this arrangement, the rest condition may include the upper limit of a rest time.

As an example, the plan generation unit 314 can generate a travel plan including a section of first following travel in which the following vehicle follows a first leading vehicle and a section of second following travel in which the following vehicle follows a second leading vehicle. At this time, the plan generation unit 314 can generate the travel plan such that at a rest point in the travel plan, the section of first following travel ends, and the section of second following travel starts.

In this embodiment, a transmission unit 315 can transmit information concerning the rest point in the travel plan to the user of the following vehicle 202. For example, as a part of information representing the travel plan, the transmission unit 315 can transmit information concerning a rest point to the terminal 320 used by the user of the following vehicle 202. Examples of the information concerning a rest point are the position of the rest point, and the name or type of a facility selected as the rest point. Also, the transmission unit 315 may provide, as the information concerning the rest point, a coupon for the facility used as the rest point to the user of the following vehicle 202. By using the coupon at the rest point, the user of the following vehicle 202 can obtain a benefit such as a discount on a merchandise or a service or reception of an additional merchandise or service. Also, as a part of information representing the travel plan, the transmission unit 315 can transmit information representing the rest time at the rest point to the terminal 320 used by the user of the following vehicle 202.

Generation of a travel plan considering such a rest condition can be performed by a vehicle search unit 313 and the plan generation unit 314 in steps S804 to S812. For example, if a rest interval is set as a rest condition, in step S809, the plan generation unit 314 can judge whether the following vehicle 202 can arrive at the destination without increasing the continuous travel time beyond the designated rest interval. The continuous travel time can be a time in which the following vehicle 202 travels without a rest or a time in which the following vehicle 202 follows the same leading vehicle 201. If it is not possible to arrive, in step S810, the plan generation unit 314 can calculate a following travel route and a necessary time until a set takeover point so the continuous travel time of the following vehicle 202 does not exceed the designated rest interval, and can also set the rest time at the takeover point. With this travel plan, the user of the following vehicle 202 can wait for the arrival of the leading vehicle 201 while taking a rest at the takeover point. Then, in step S811, the vehicle search unit 313 can search for a candidate of the leading vehicle 201 capable of leading the following vehicle 202 from the takeover point near a time after the rest at the takeover point.

At this time, if a rest time of each rest is designated as the rest condition, in step S810, the plan generation unit 314 can set a rest time complying with the condition. If the upper limit of a rest time of each rest is designated as the rest condition, in step S811, the vehicle search unit 313 can search for a candidate of the leading vehicle 201 capable of leading the following vehicle 202 from the takeover point within the time complying with the rest condition. If such a candidate of the leading vehicle 201 cannot be found, the process may advance from step S805 to step S806, and a travel plan for performing manual driving from the takeover point may thus be generated.

If a condition concerning a facility used as a rest point is designated, in step S810, the plan generation unit 314 can select a takeover point complying with the condition. Here, based on information representing the business hours of a facility used as the rest point, the plan generation unit 314 can select, as a takeover point, a facility that is open at the scheduled arrival time. Also, the plan generation unit 314 may preferentially select, as a takeover point, a facility that provides a coupon to the user of the following vehicle 202. The plan generation unit 314 need not always select a takeover point complying with the condition concerning a facility used as a rest point. For example, the plan generation unit 314 may preferentially select a takeover point complying with the condition, and if a takeover point complying with the condition cannot be found, may select a takeover point that does not comply with the condition.

As another method, in steps S809 and S810, the plan generation unit 314 may consider whether the candidate of the leading vehicle 201 found in step S804 can take a rest during lead in following travel. If the candidate of the leading vehicle 201 can arrive at the destination while taking a rest during lead, the process may advance to step S812. In this case, the travel plan can include a section of following travel led by the same leading vehicle 201 with a rest complying with the rest condition. Similarly, in step S810, the plan generation unit 314 can calculate the route and the necessary time of following travel led by the same leading vehicle 201 with a rest complying with the rest condition. For example, information representing whether the candidate of the leading vehicle 201 can take a rest can be stored in a DB 1111 in advance. For example, a specialized vehicle may be able to take a rest during lead, and a delivery vehicle may be unable to take a rest during lead.

Similarly, in step S803, a course search unit 312 may set the end point of an autonomous travel section and a rest time at the end point in accordance with the rest condition. Additionally, in step S807, the plan generation unit 314 may set the end point of a manual travel section and a rest time at the end point in accordance with the rest condition. In this case as well, in step S804 or S807, the vehicle search unit 313 can search for a candidate of the leading vehicle 201 capable of leading the following vehicle 202 from the end point of the autonomous travel section or manual travel section (that is, a takeover point) near a time after the rest. Also, in step S803 or S807, the course search unit 312 may set a rest point and a rest time at a middle point of the autonomous travel section or the manual travel section in accordance with the rest condition.

In step S802, the obtaining unit 311 can obtain information representing the rest condition.

FIG. 6 already described above shows a travel plan in which during the time when the user of a following vehicle 600 is taking a rest at a takeover point 613 that is a rest point, the vehicle that leads the following vehicle 600 changes from a leading vehicle 601 to a leading vehicle 602.

If a travel plan including a rest is generated, as described above, the user of the following vehicle 202 is expected to arrive at the rest point at the scheduled time. Hence, the transmission unit 315 may further have a function of transmitting the scheduled time of arrival at the rest point in the travel plan to a terminal used by a user at the rest point. According to this arrangement, the user in the facility at the rest point can prepare for the arrival of the following vehicle 202 and prepare, for example, a merchandise or a service in accordance with the number of visitors.

In addition, the transmission unit 315 may have a function of obtaining, from the user of the following vehicle 202, an order of a merchandise or a service provided at the rest point in the travel plan and transmitting the order to a terminal used by a user at the rest point. For example, the user in the facility at the rest point can provide information concerning a merchandise or a service provided at the rest point to the user of the following vehicle 202. The user of the following vehicle 202, who has viewed the information, can make an order of the merchandise or the service before arrival at the rest point. According to this arrangement, the user in the facility at the rest point can provide the merchandise or the service at the timing of the arrival of the user of the following vehicle 202.

### Fifth Embodiment

In a vehicle following travel system according to the fifth embodiment, a travel plan is generated in consideration of the drivable distance of a following vehicle or a leading vehicle. According to this arrangement, it is possible to perform travel while increasing the drivable distance of the following vehicle or the leading vehicle by stopping by a facility for increasing the drivable distance halfway through a route in accordance with the drivable distance. The vehicle following travel system according to the fifth embodiment can have an arrangement similar to that in the first embodiment, and can perform similar processing. For example, the vehicle following travel system according to the fifth embodiment may include an information processing apparatus 310, a terminal 320, and a terminal 330 shown in FIG. 3. In addition, the information processing apparatus 310 can perform processing similar to the flowchart shown in FIG. 8. Differences from the first embodiment will be described below.

In this embodiment, an obtaining unit 311 can obtain information representing the drivable distance of a following vehicle 202 in addition to a departure point and a destination desired by the user of the following vehicle 202. The information representing the drivable distance may be information representing the remaining energy amount (for example, a fuel amount or a charge amount) of the following vehicle 202 or information representing a drivable distance calculated by the following vehicle 202.

In addition, the obtaining unit 311 may obtain a setting for a service for increasing the drivable distance from the user of the following vehicle 202 or a DB 1112. For example, the obtaining unit 311 can obtain a setting representing whether to supply energy such as fuel or electricity by the user of the following vehicle 202 or by the user of a leading vehicle 201. The obtaining unit 311 can also obtain a setting representing whether to pay the fee of energy supply to the facility by the user of the following vehicle 202 or by the user of a leading vehicle 201. The obtaining unit 311 may obtain information representing the type of energy (for example, gasoline or light oil) used by the following vehicle 202.

A plan generation unit 314 can generate a travel plan such that the following vehicle 202 stops by a facility for increasing the drivable distance, which is located at a point arrivable in accordance with the drivable distance from the departure point. The plan generation unit 314 may generate a travel plan so as to stop by a facility for increasing the drivable distance at the starting point, a middle point, or the end point of a section of following travel. Also, the plan generation unit 314 may generate a travel plan so as to stop by a facility for increasing the drivable distance in a section of autonomous travel or manual travel.

The method of selecting the facility for increasing the drivable distance by the plan generation unit 314 is not particularly limited. For example, the plan generation unit 314 can select a facility for increasing the drivable distance, which is located at a point where the following vehicle 202 receives energy supply during the time when the drivable distance of the following vehicle 202 falls within a predetermined range. Alternatively, the plan generation unit 314 may select a facility for increasing the drivable distance, which the following vehicle stops by in the travel plan, depending on whether the facility for increasing the drivable distance provides information to be used for a discount on the fee of energy supply. For example, the facility for increasing the drivable distance may provide a larger discount on the fee of energy supply to a user of the vehicle following travel system than to other users. In this case, the plan generation unit 314 can preferentially select a facility that provides such a discount. In addition, the plan generation unit 314 may select a facility for increasing the drivable distance, which the following vehicle stops by in the travel plan, in accordance with the fee of energy supply.

In this arrangement, a transmission unit 315 can transmit information representing a section of following travel to the terminal used by the user of the leading vehicle 201, as in the second embodiment. The user of the leading vehicle 201 can lead the following vehicle 202 to the destination or a takeover point via the facility for increasing the drivable distance in accordance with the information representing the section of following travel.

In the facility for increasing the drivable distance, the user of the following vehicle 202 may supply energy to the following vehicle 202 or request staff of the facility to supply energy to the following vehicle 202. On the other hand, the user of the leading vehicle 201 may supply energy to the following vehicle 202 or request staff of the facility to supply energy to the following vehicle 202. In accordance with the setting obtained by the obtaining unit 311, the transmission unit 315 can transmit information representing whether the user of the leading vehicle 201 should supply energy to the following vehicle 202 or request supply to the terminal used by the user of the leading vehicle 201. In accordance with the setting obtained by the obtaining unit 311, the transmission unit 315 may transmit information representing the type of energy used by the following vehicle 202 to the terminal used by the user of the leading vehicle 201.

Also, in the facility for increasing the drivable distance, the user of the following vehicle 202 may pay, to the facility, the fee of energy supplied to the following vehicle 202, or the user of the leading vehicle 201 may pay, to the facility, the fee of energy supplied to the following vehicle 202. In accordance with the setting obtained by the obtaining unit 311, the transmission unit 315 can transmit information representing whether the user of the leading vehicle 201 should pay, to the facility, the fee of energy supply to the following vehicle 202 to the terminal used by the user of the leading vehicle 201.

If the user of the leading vehicle 201 should pay, to the facility, the fee of energy supplied to the following vehicle 202, the user of the leading vehicle 201 can charge the user of the following vehicle 202 with the fee of energy. For this purpose, the information processing apparatus 310 may include a payment unit (not shown) that performs payment processing from the following vehicle 202 to the leading vehicle 201, as in the third embodiment. The payment unit can perform payment processing of the fee of energy supplied to the following vehicle 202 in the facility for increasing the drivable distance from the following vehicle 202 to the leading vehicle 201.

Furthermore, as in the third embodiment, an arrangement in which the following vehicle that has performed following travel pays a reward to the leading vehicle may be employed. In this case, as described in the third embodiment, the information processing apparatus 310 can include a reward calculation unit 316 that calculates a reward for following travel from the following vehicle to the leading vehicle based on a travel plan. The reward can include the fee of energy supplied to the following vehicle in the facility for increasing the drivable distance.

Generation of a travel plan considering such a drivable distance can be performed by a vehicle search unit 313 and the plan generation unit 314 in steps S804 to S812. For example, in steps S810 and S812, the plan generation unit 314 can judge whether the following vehicle 202 can arrive at the destination or a takeover point within the range of the drivable distance of the following vehicle 202. If it is not possible to arrive, the plan generation unit 314 can calculate a following travel route and a necessary time such that the following vehicle 202 travels to the destination or the takeover point after stopping by a facility for increasing the drivable distance to supply energy to the following vehicle 202. In step S802, the obtaining unit 311 can obtain information representing the drivable distance.

If the following vehicle 202 cannot arrive at the destination or the takeover point within the range of the drivable distance, the plan generation unit 314 may set a facility for increasing the drivable distance as a rest point. In this case, in the facility for increasing the drivable distance, takeover from following travel to a first leading vehicle to following travel to a second leading vehicle may be performed. Such processing can be performed as in the fourth embodiment.

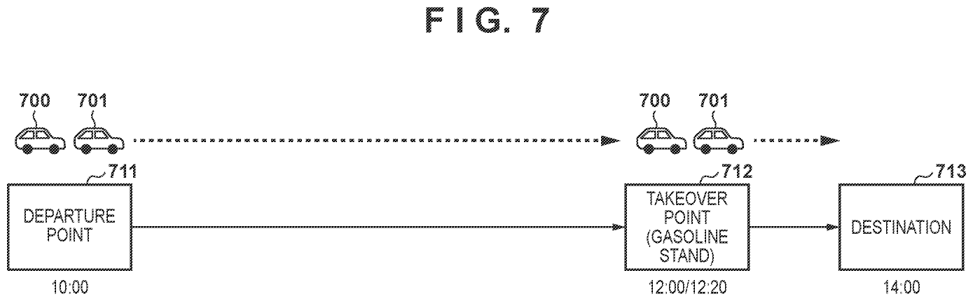

FIG. 7 shows a travel plan in which during lead of a following vehicle 700 by a leading vehicle 701, energy supply is performed at a takeover point 712 that is a gas station. In this travel plan, the following vehicle 700 departs from a departure point 711 following the leading vehicle 701 at 10:00, and arrives at the takeover point 712 at 12:00. At the takeover point 712, energy is supplied. The following vehicle 700 departs from the takeover point 712 following the leading vehicle 701 at 12:20, and arrives at a destination 713 at 14:00.

A method of generating a travel plan based on the drivable distance of the following vehicle 202 has been described above. On the other hand, a travel plan may be generated based on the drivable distance of the leading vehicle 201. In this arrangement, the obtaining unit 311 can obtain information representing the drivable distance of the leading vehicle 201. The plan generation unit 314 can generate a travel plan of following travel while judging whether to stop by a facility for increasing the drivable distance in accordance with the drivable distance of the leading vehicle 201.

For example, in steps S810 and S812, the plan generation unit 314 can judge whether the leading vehicle 201 can arrive at the destination or a takeover point within the range of the drivable distance of the leading vehicle 201. If it is not possible to arrive, the plan generation unit 314 can calculate a following travel route and a necessary time such that the leading vehicle 201 travels to the destination or the takeover point after stopping by a facility for increasing the drivable distance to supply energy to the leading vehicle 201.

When supplying energy to the leading vehicle 201, the arrival of the following vehicle 202 at the destination is expected to delay. Hence, if energy is supplied to the leading vehicle 201, the user of the leading vehicle 201 may pay a charge to the user of the following vehicle 202. For example, if an arrangement in which the following vehicle that has performed following travel pays a reward to the leading vehicle is employed, as in the third embodiment, the reward may be discounted in accordance with the energy supply to the leading vehicle in the facility for increasing the drivable distance.

An example in which the travel plan from the departure point to the destination is created in consideration of the drivable distance has been described above. However, after the start of travel according to a travel plan, a travel plan corrected in consideration of the drivable distance may be generated. For example, if the drivable distance of the leading vehicle 201 or the following vehicle 202 becomes deficient during following travel, a corrected following travel route can be generated such that the vehicle travels to the destination or a takeover point via a facility for increasing the drivable distance.

### Sixth Embodiment

In a vehicle following travel system according to the sixth embodiment, following travel is set in consideration of the motion performance of each of a leading vehicle and a following vehicle. According to this arrangement, it is possible to select a leading vehicle suitable for lead or limit driving of the leading vehicle such that the following vehicle can follow it. The vehicle following travel system according to the sixth embodiment can have an arrangement similar to that in the first embodiment, and can perform similar processing. For example, the vehicle following travel system according to the sixth embodiment may include an information processing apparatus 310, a terminal 320, and a terminal 330 shown in FIG. 3. In addition, the information processing apparatus 310 can perform processing similar to the flowchart shown in FIG. 8. Differences from the first embodiment will be described below.

In this embodiment, an obtaining unit 311 obtains information representing the motion performance of each of a following vehicle 202 and a leading vehicle 201. The obtaining unit 311 can obtain information representing the motion performance of the leading vehicle 201 from a DB 1111, and can obtain information representing the motion performance of the following vehicle 202 from a DB 1112. Examples of information representing motion performance are a maximum speed, a maximum acceleration, a maximum braking force, a maximum steering angle, and a minimum turning radius.

Based on the information representing the motion performance of each of the following vehicle 202 and the leading vehicle 201, a vehicle search unit 313 can search for the leading vehicle 201 that the following vehicle 202 follows. For example, the vehicle search unit 313 can search for the leading vehicle 201 having motion performance similar to that of the following vehicle 202 such that the following vehicle 202 can follow the leading vehicle 201. The vehicle search unit 313 may calculate the maximum speed in accordance with weather information such as a road surface state.

A case in which the leading vehicle 201 is searched for based on the maximum braking forces of the following vehicle 202 and the leading vehicle 201 will be described below as a detailed example. When performing following travel, to reduce the possibility that another vehicle cuts in between the leading vehicle 201 and the following vehicle 202, the inter-vehicle distance between the leading vehicle 201 and the following vehicle 202 can be made short. On the other hand, if the inter-vehicle distance between the leading vehicle 201 and the following vehicle 202 is short, to reduce the possibility that the following vehicle 202 collides against the leading vehicle 201 at the time of abrupt deceleration of the leading vehicle 201, the speed of following travel may be required to be low. In this example, the vehicle search unit 313 can search for the leading vehicle 201 based on the maximum braking forces of the following vehicle 202 and the leading vehicle 201 such that the speed of following travel exceeds a threshold.

To prevent the following vehicle 202 from colliding against the leading vehicle 201 at the time of abrupt deceleration of the leading vehicle 201, the relationship between the braking distance of the leading vehicle 201 and the braking distance of the following vehicle 202 can be set as follows.

(braking distance of following vehicle 202)−(braking distance of leading vehicle 201)≤(inter-vehicle distance)−(margin)

In the above-described expression, the margin represents a distance provided between the leading vehicle 201 and the following vehicle 202 when the leading vehicle 201 and the following vehicle 202 abruptly decelerate and stop. Here, the braking distance is generally determined by the speed and the braking force. The higher the speed is, the longer the braking distance is. Hence, the maximum speed of following travel can be calculated based on the braking forces of the leading vehicle 201 and the following vehicle 202 such that the above expression is satisfied. Also, a time lag from the start of braking by the leading vehicle 201 to the start of braking by the following vehicle 202 may be taken into consideration.

On the other hand, when the leading vehicle 201 is selected such that the maximum speed of following travel become high, it is possible to make the necessary time to the destination short or prevent traffic of other vehicles from being impeded. From this viewpoint, in an embodiment, the vehicle search unit 313 can search for the leading vehicle 201 in accordance with the maximum speed of following travel obtained based on the information representing the motion performance of each of the following vehicle 202 and the leading vehicle 201. More specifically, the vehicle search unit 313 can search for the leading vehicle 201 such that the maximum speed of following travel obtained in the above-described way becomes equal to or more than a threshold.

Note that the inter-vehicle distance used when calculating the maximum speed may be a fixed value or may change in accordance with the course of following travel. For example, the maximum speed of following travel may be obtained further based on the course of following travel. As a detailed example, in a section such as an expressway where the traffic flows fast, the possibility of cut-in by another vehicle is low even if the inter-vehicle distance is long. Hence, a long inter-vehicle distance (for example, 4 m) can be used. On the other hand, in a section where the traffic flows slowly, the possibility of cut-in by another vehicle is high even if the inter-vehicle distance is short. Hence, a short inter-vehicle distance (for example, 2 m) can be used. When performing following travel according to a travel plan, a motion control unit 224 of the following vehicle 202 can control the travel of the following vehicle 202 to maintain the inter-vehicle distance used when calculating the maximum speed.

In another embodiment, the vehicle search unit 313 may decide to provide a cut-in preventing member between the following vehicle 202 and the leading vehicle 201 based on the information representing the motion performance of each of the following vehicle 202 and the leading vehicle 201. For example, if the maximum speed of following travel obtained based on the information representing the motion performance of each of the following vehicle 202 and the leading vehicle 201 is less than a threshold, the vehicle search unit 313 can decide to provide the cut-in preventing member. The cut-in preventing member is a member that connects the following vehicle 202 and the leading vehicle 201 to prevent another vehicle from cutting in between the following vehicle 202 and the leading vehicle 201, and may be, for example, a string-like member such as a traction rope. To improve visibility from another vehicle, the cut-in preventing member may include a string-like member that connects the following vehicle 202 and the leading vehicle 201, and a marker portion that is provided at, for example, the center portion of the string-like member and is visible from other vehicles.

If such a cut-in preventing member is provided, the inter-vehicle distance between the following vehicle 202 and the leading vehicle 201 can be increased. The vehicle search unit 313 may calculate the maximum speed of following travel based on the inter-vehicle distance in a case in which the cut-in preventing member is provided. The inter-vehicle distance in a case in which the cut-in preventing member is provided can be set to be longer than the inter-vehicle distance in a case in which the cut-in preventing member is not provided and shorter than the length of the cut-in preventing member. In addition, the vehicle search unit 313 may search for the leading vehicle 201 such that the maximum speed of following travel becomes equal to or more than the threshold at least in a case in which the cut-in preventing member is provided.

In this arrangement, a transmission unit 315 can transmit information representing the maximum speed of following travel obtained based on the information representing the motion performance of each of the following vehicle 202 and the leading vehicle 201 to the leading vehicle 201 or the user of the leading vehicle 201. For example, when the transmission unit 315 transmits the information representing the maximum speed of following travel to a terminal used by the user of the leading vehicle 201, the user of the leading vehicle 201 can drive the leading vehicle 201 so as not to exceed the maximum speed. Also, when the transmission unit 315 transmits the information representing the maximum speed to the leading vehicle 201, it is possible to cause the leading vehicle 201 to control the travel speed in accordance with the maximum speed. More specifically, a processing unit 214 of the leading vehicle 201 can control the travel of the leading vehicle 201 so the speed of the leading vehicle 201 does not exceed the maximum speed.

Also, as described above, the vehicle search unit 313 can decide to provide the cut-in preventing member between the following vehicle 202 and the leading vehicle 201 based on the information representing the maximum speed of following travel obtained based on the information representing the motion performance of each of the following vehicle 202 and the leading vehicle 201. In this case, a notification for requesting to provide the cut-in preventing member between the following vehicle 202 and the leading vehicle 201 can be transmitted to the user of the leading vehicle 201. With this arrangement, the user of the leading vehicle 201 can install the cut-in preventing member in accordance with the notification and then start lead of following travel. More specifically, the processing unit 214 of the leading vehicle 201 may control the travel of the leading vehicle 201 such that lead of following travel is started after confirming installation of the cut-in preventing member.

The calculation of the maximum speed and the search of the leading vehicle 201 can be performed by the vehicle search unit 313 in steps S804, S807, and S811. In step S802, the obtaining unit 311 can obtain the information representing the motion performance of each of the following vehicle 202 and the leading vehicle 201. In step S816, the transmission unit 315 can transmit the information representing the maximum speed.

In association with the vehicle following travel system according to the first embodiment, a case in which following travel is set in consideration of the motion performance of each of the leading vehicle and the following vehicle has mainly been described above. However, in this embodiment, it is not essential to generate a travel plan from a departure point to a destination. In an embodiment, the leading vehicle that the following vehicle follows is searched for based on the information representing the motion performance of each of the following vehicle and the leading vehicle, thereby selecting the leading vehicle suitable for lead of following travel. Also, in this embodiment, it is not essential to search for the leading vehicle. In an embodiment, when information representing the maximum speed of following travel obtained based on the information representing the motion performance of each of the following vehicle and the leading vehicle is transmitted to the leading vehicle or the user of the leading vehicle, the leading vehicle can easily be caused to travel such that the following vehicle can follow it. Also, in an embodiment, based on the information representing the motion performance of each of the following vehicle and the leading vehicle, a notification for requesting to provide the cut-in preventing member between the following vehicle and the leading vehicle is transmitted to the user of the leading vehicle, thereby improving the speed of following travel.

### Summary of Embodiments

The above-described embodiments disclose at least the following vehicle following travel system, information processing method, and program.

1. A vehicle following travel system according to the above-described embodiment is

a vehicle following travel system configured to cause a following vehicle (202) to perform following travel following a leading vehicle (201), comprising:

a memory storing a program, and:

one or more processor which, by executing the program, perform:

obtaining a departure point and a destination desired by a user of the following vehicle (202) and a rest condition desired by the user of the following vehicle (202);

searching, based on the departure point and the destination, for the leading vehicle (201) that the following vehicle (202) follows, and

generating a travel plan that includes a section of the following travel in at least a part between the departure point and the destination and further includes a rest complying with the rest condition.

According to this embodiment, in the vehicle following travel system, it is possible to take a rest in accordance with the desire of the user of the following vehicle.

2. In the vehicle following travel system according to the above-described embodiment,

the rest condition includes a condition concerning one of presence/absence of the rest, an interval of the rests, a time of each rest, and a facility used as a rest point.

According to this embodiment, it is possible to take a rest in accordance with the condition desired by the user of the following vehicle.

3. In the vehicle following travel system according to the above-described embodiment,

the system further transmits information concerning a rest point in the travel plan to the user of the following vehicle (202).

According to this embodiment, the user of the following vehicle can know the rest point.

4. In the vehicle following travel system according to the above-described embodiment,

the information concerning the rest point is a coupon for a facility used as the rest point.

According to this embodiment, the user of the following vehicle can obtain a benefit at the rest point.

5. In the vehicle following travel system according to the above-described embodiment,

the system further transmits a scheduled arrival time at a rest point in the travel plan to a terminal used by a user at the rest point.

According to this embodiment, the user at the rest point can prepare for the arrival of the following vehicle.

6. In the vehicle following travel system according to the above-described embodiment,

the system further obtains an order of one of a merchandise and a service provided at a rest point in the travel plan from the user of the following vehicle (202) and transmit the order to a terminal used by a user at the rest point.

According to this embodiment, the user in a facility located at the rest point can provide the merchandise or the service at the timing of the arrival of the following vehicle.

7. In the vehicle following travel system according to the above-described embodiment,

the generating generates the travel plan to take the rest at one of a starting point, a middle point, and an end point of the section of the following travel or at one of a starting point, a middle point, and an end point of a section of autonomous travel in which the following vehicle (202) solely performs automated travel.

According to this embodiment, the user of the following vehicle can take a rest halfway through or before/after automated driving.

8. In the vehicle following travel system according to the above-described embodiment,

the generating generates the travel plan such that the travel plan includes a first section of following travel in which the following vehicle (202) follows a first leading vehicle and a second section of following travel in which the following vehicle (202) follows a second leading vehicle, and at a rest point in the travel plan, the first section of the following travel ends, and the second section of the following travel starts.

According to this embodiment, the user of the following vehicle can wait for the arrival of the leading vehicle while taking a rest at a takeover point.

9. An information processing method according to the above-described embodiment is

an information processing method performed by a vehicle following travel system configured to cause a following vehicle (202) to perform following travel following a leading vehicle (201), comprising:

obtaining a departure point and a destination desired by a user of the following vehicle (202) and a rest condition desired by the user of the following vehicle (202) (S802);

searching, based on the departure point and the destination, for the leading vehicle (201) that the following vehicle (202) follows (S804, S807, S811); and

generating a travel plan that includes a section of the following travel in at least a part between the departure point and the destination and further includes a rest complying with the rest condition (S810, S812).

According to this embodiment, in the vehicle following travel system, it is possible to take a rest in accordance with the desire of the user of the following vehicle.

10. A program according to the above-described embodiment

causes a computer to function as each unit of a vehicle following travel system according to the above-described embodiment.

According to this embodiment, in the vehicle following travel system, it is possible to take a rest in accordance with the desire of the user of the following vehicle.

Preferred embodiments of the present invention have been described above. However, the present invention is not limited to the embodiments, and various changes and modifications can be made without departing from the scope of the present invention.

The invention is not limited to the foregoing embodiments, and various variations/changes are possible within the spirit of the invention.

What is claimed is:

1. A vehicle following travel system configured to cause a following vehicle to perform following travel following a leading vehicle, comprising:
a memory storing a program, and;
one or more processor which, by executing the program, perform;
obtaining a departure point and a destination desired by a user of the following vehicle and a rest condition desired by the user of the following vehicle;
searching, based on the departure point and the destination, for the leading vehicle that the following vehicle follows; and
generating a travel plan that includes a section of the following travel in at least a part between the departure point and the destination and further includes a rest complying with the rest condition.

2. The system according to claim 1, wherein the rest condition includes a condition concerning one of presence/absence of the rest, an interval of the rests, a time of each rest, and a facility used as a rest point.

3. The system according to claim 1, further transmitting information concerning a rest point in the travel plan to the user of the following vehicle.

4. The system according to claim 3, wherein the information concerning the rest point is a coupon for a facility used as the rest point.

5. The system according to claim 1, further transmitting a scheduled arrival time at a rest point in the travel plan to a terminal used by a user at the rest point.

6. The system according to claim 1, further obtaining an order of one of a merchandise and a service provided at a rest point in the travel plan from the user of the following vehicle and transmit the order to a terminal used by a user at the rest point.

7. The system according to claim 1, wherein the generating generates the travel plan to take the rest at one of a starting point, a middle point, and an end point of the section of the following travel or at one of a starting point, a middle point, and an end point of a section of autonomous travel in which the following vehicle solely performs automated travel.

8. The system according to claim 1, wherein the generating generates the travel plan such that the travel plan includes a first section of following travel in which the following vehicle follows a first leading vehicle and a second section of following travel in which the following vehicle follows a second leading vehicle, and at a rest point in the travel plan, the first section of the following travel ends, and the second section of the following travel starts.

9. An information processing method performed by a vehicle following travel system configured to cause a following vehicle to perform following travel following a leading vehicle, comprising:
obtaining a departure point and a destination desired by a user of the following vehicle and a rest condition desired by the user of the following vehicle;
searching, based on the departure point and the destination, for the leading vehicle that the following vehicle follows; and
generating a travel plan that includes a section of the following travel in at least a part between the departure point and the destination and further includes a rest complying with the rest condition.

10. A non-transitory computer-readable storage medium storing a program that, when executed by a computer, causes the computer to perform an information processing method performed by a vehicle following travel system configured to cause a following vehicle to perform following travel following a leading vehicle, comprising:
obtaining a departure point and a destination desired by a user of the following vehicle and a rest condition desired by the user of the following vehicle;
searching, based on the departure point and the destination, for the leading vehicle that the following vehicle follows; and
generating a travel plan that includes a section of the following travel in at least a part between the departure point and the destination and further includes a rest complying with the rest condition.
